(19) United States
(12) Patent Application Publication
(10) Pub. No.: US 2022/0362090 A1
(43) Pub. Date: Nov. 17, 2022

(54) A MULTIFUNCTIONAL APPARATUS

(71) Applicant: Guanghui XUE, Gatineau, Quebec (CA)

(72) Inventor: Guanghui XUE, Gatineau, Quebec (CA)

(21) Appl. No.: 17/273,551

(22) PCT Filed: Feb. 4, 2020
(86) PCT No.: PCT/CA2020/050133

§ 371 Date: Mar. 4, 2021

(51) Int. Cl. A61H 1/02

(52) U.S. Cl. CPC A61H 1/0218; A61H 2201/1623; A61H 2201/1638; A61H 2203/0431; A61H 2201/1207; A61H 2201/1246; A61H 2001/0233; A61H 2201/0192; A61H 2201/1642; A61H 2201/1633; A61H 2201/0149; A61H 2201/5025; A61H 2201/1261

(57) ABSTRACT

A device for physiotherapy includes at least a seating surface and a back rest. The back rest is provided with arm holders positionable under a person's underarms. The back rest is also provided with powered apparatus to move the arm holders in a direction away from the seating surface, thereby to lift a person off the seating surface, and to return the person to the seating surface.

### FIELD OF INVENTION

The present invention relates to the field of exercise and physiotherapy equipment, In particular, the present invention provides a multifunctional device for applying traction to a person's spine and back muscles to reduce back pain and strengthen back muscles.

### BACKGROUND OF THE INVENTION

In many cases of spinal injury, including compression, bulging disc, and pinched nerves, it is considered both therapeutic and analgesic to apply traction to the spine. Various devices and techniques have been utilized by practitioners, and developed by inventors over the years. These include: U.S. Pat. No. 5,971,901 (Shaw) shows a device that supports a user's underarm, with the body at an angle, and the legs supported under the knees, to provide lower back traction. It does not show that the under-arm support can be motorized to lift a person and therefore also does not show a programmable cycle of lifting and lowering. Moreover, it is a single purpose device and it does not have another integrated function other than back traction i.e. back pain therapeutic function combining both spinal traction and back muscle strengthen in order to achieve better effects.

U.S. Pat. No. 6,106,490 (Shaw) is similar to U.S. Pat. No. 5,971,901 but provides a vibratory pad to massage lower back muscles. US 2018/0360641 (Budge) shows a device to lift a person by their underarms. It can be incorporated into a chair but does not electronically cycle between lifting and lowering. U.S. Pat. No. 5,347,609 (Leonard) shows a chair that can be made to apply traction but by dropping the seating surface.

### SUMMARY OF THE INVENTION

It is the objective of the present invention to provide a physiotherapy apparatus that combines the functions of spinal traction and lower back muscle exercise to control back pain. The approach of the present invention is to provide a physiotherapy device that reduces the vertical pressure of the spine, and to provide the appropriate exercise equipment for lower back muscle exercise. The approach of the present invention is to provide a versatile apparatus. The present invention is adjustable to fit different user's body sizes. The present invention provides the possibility that the user performs spinal traction and lower back muscle exercise on the same equipment.

In particular, the present invention provides a device that can accommodate a person in a seated, but somewhat reclined position. The person's torso is positioned on a padded bench-like surface, between a pair of supports that are laterally displaceable to be comfortably situated under the persons armpit. There is a cushioned support seat provided under the person's buttocks, and an elevated pad that the person can hook their knees over. The supports that are positioned under the armpits are connected to a motor so that by activating the motor, the supports will gently lift the person off the cushioned support seat, whereby the person's body weight will apply a traction force to spine in the area of the lower back. The motor is programmable to operate in cycles, to lift a person's weight for a programmed length of time, and then lower them, and after a predetermined rest period, lift them again. The program of lift and rest is effective in providing traction and is effective in assisting persons to relax the muscles of the lower back, which makes the traction more effective.

The device of the present invention is also, without modification, usable as a Roman chain exercise device, which permits a person to exercise the lower back, as well as relax it and apply traction.

In a broad aspect, then, the present invention provides:

1. A device for physiotherapy comprising at least a seating surface and a back rest; said back rest being provided with arm holders positonable under a person's underarms; said back rest also being provided with powered means to move said arm holders in a direction away from said seating surface, thereby to lift a person off the seating surface, and to return the person to the seating surface.

2. A device as in 1, wherein said back rest is at an angle of 90° or greater to said seating surface.

3. A device as in 1 or 2, wherein said seating surface is mounted on a first beam extending at an angle from a floor contacting lower end to an upper end connected to a second beam extending from the floor to a point above the point of connection with said first beam.

4. A device as in 1, 2 or 3, wherein said back rest is mounted on a third beam that extends upwardly from the first beam.

5. A device as in any one of 1-4, wherein said powered means comprises; a lower element that can be placed in a fixed position relative to said seating surface, an upper element that is connected to said arm holders and is moveable relative to said lower element, and an actuator element extending between said lower element and said upper element.

6. A device as in 5, wherein said actuator element is functionally connected to a power element to cause said upper element to move away from the lower element.

7. A device as in 6, wherein the power element is an electric motor including drive means to power said actuator to move said upper element away from said lower element, and permit said upper element to return to its original position.

8. A device as in 6, wherein said power element is a pneumatic cylinder connected to a source of compressed air, and said actuator is a piston rod extending from said pneumatic cylinder.

9. A device as in 7, wherein said power element is connected to a controller that is operable to operate the actuator and lift the upper element in a cyclic manner of lift, wait, and lower, for preselected or programmable length of time.

10. A device as in 8, wherein said pneumatic cylinder is connected to a controller to permit a person to pressurize the cylinder and thereby raise the upper element, and depressurize the cylinder to lower the upper element as desired.

11. A device as in any one of 5-10, wherein said back rest is connected to said upper element.

12. A device as in 11, further comprising a back support mounted on said third beam and having tracks formed therein to accept wheels provided on at least said upper element.

13. A device as in 11, wherein said lower element is also provided with wheels that fit in said tracks, and stop means are provided to limit the extent of downward travel in said tracks by said lower element.

14. A device as in 13, wherein said stop means comprise a bolt co-operable with any one of a series of threaded holes at different heights in said back support.

15. A device for physiotherapy comprising a structural frame with a first frame member having a first floor engaging base, a second frame member extending away from the first frame member near an upper end thereof remote from said floor engaging base and terminating in a second floor engaging base, and a third frame member extending upwardly from said second frame member; said first frame member having, at its uppermost end one or two pads to accommodate the legs of a user; said second frame member having a seating surface connected thereto, for a user to sit on; said third frame member having a rigid element mounted thereon, with laterally spaced apart tracks in which is slidably mounted a back rest device; said back rest device having a lower portion, and an upper portion, the lower portion and upper portion of the back rest device each being provided with a plurality of wheels that fit in said tracks to permit said lower and upper portions to move in said tracks, said lower and upper portions being joined together by an actuator means that comprises an elongated rod extending between the lower and upper portions; said upper portion of said back rest comprising a pair of arm holders that can be moved apart a selected distance to accommodate different sized users; wherein said actuator means is functional to push said upper portion of said back rest away from said lower portion, and to return the upper portion to a rest position, thereby to lift the weight of a user who is seated on the seating surface, with their legs over the pad on the first frame member, and their arms over the arm holders, and to return the user to a rest position, repeatedly.

16. A device as in 15, wherein a footrest is provided at the lowermost end of said first frame member.

17. A device as in 16, wherein a leg support is provided in connection with said frame member, vertically spaced from the floor engaging end of the first frame member.

18. A device as in 17, wherein said leg support is T-shaped, and is hingedly connected at the base position of the T to the first frame member, whereby the cross portion of the T can be pivoted away from the first frame member to permit a person to stand with their feet on the foot rests, their calves against the T-shaped leg support, and their waist at the padded upper end of the first frame member, thereby to use the device to perform back extension exercises in the manner of a Roman chair.

19. A device as in 18, wherein the cross portion of the T-shaped leg support is padded.

20. A device as in any one of 15-19, wherein said actuator comprises an electric motor affixed to a selected one of the upper and lower portions of the back rest device and having a rod extending therefrom; said motor selectively or programmably driving said rod in a first direction to extend said upper portion of the back rest away from the lower portion of the back rest, and in a second direction to retract said upper portion of said back rest toward the lower portion of the back rest.

2.1. A device as in any one of 15-19, wherein said actuator is a pneumatic cylinder connected to a source of compressed gas and having an extensible rod extending therefrom; a selected one of the cylinder and the rod being connected to the upper position of the back rest device, and the other of the rod and cylinder being connected to the lower portion of the back rest device; whereby selective pressurization of the cylinder with pressurized gas extends the rod from the cylinder to urge the upper portion of the back rest device up to raise the user, and depressurization of the cylinder permits the upper portion of the back rest device to return.

In drawings, that illustrate the present invention by way of example:

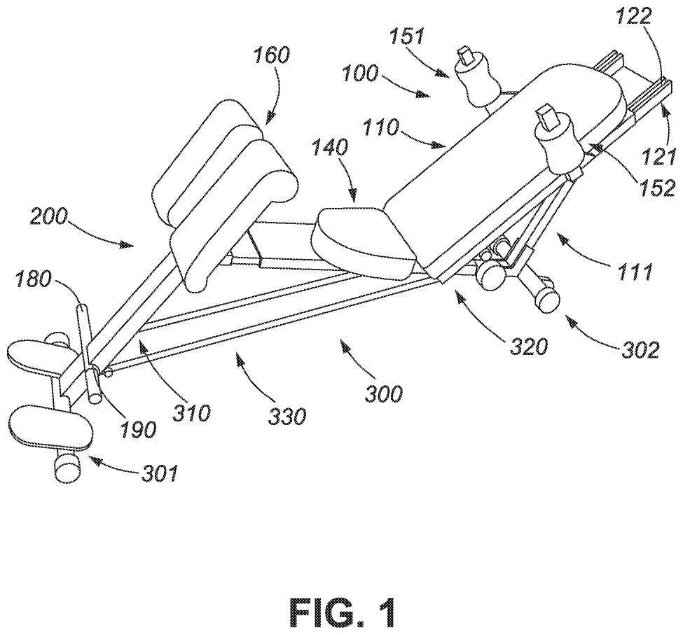

FIG. 1 is a perspective view of the apparatus of the present invention.

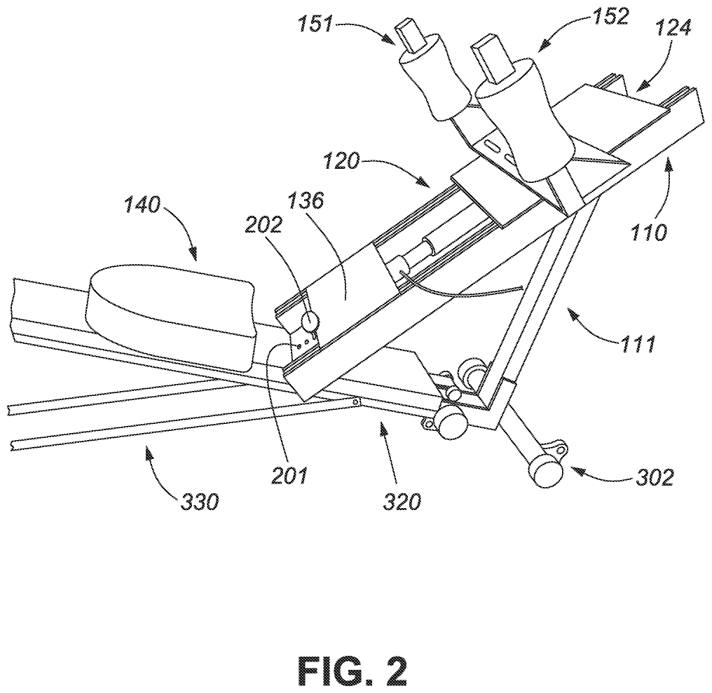

FIG. 2 is a perspective view of the back support apparatus shown in FIG. 1, with the padding removed.

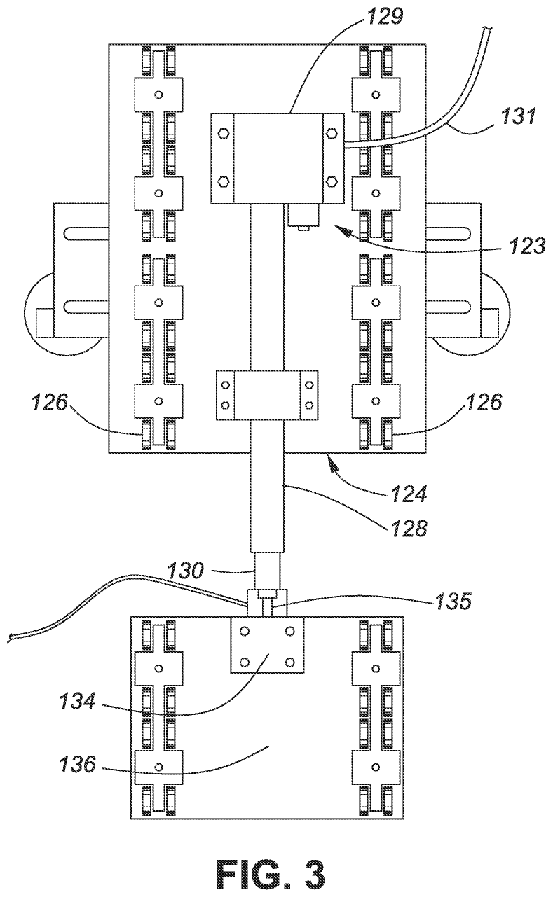

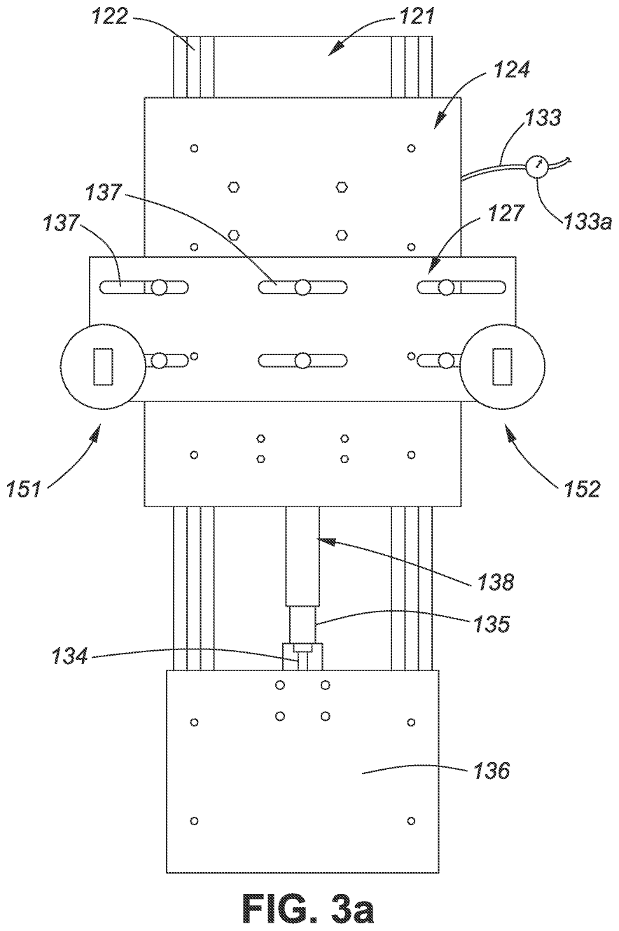

FIG. 3 is a rear view of the sliding portion of the apparatus of FIG. 1, showing an electric actuator.

FIG. 3a is the same view as FIG. 3, showing a pneumatic actuator.

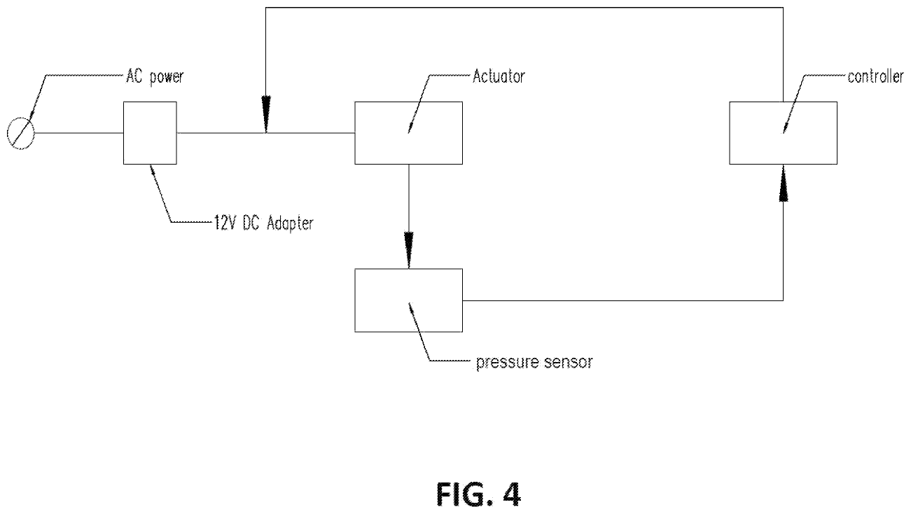

FIG. 4 is a schematic view of the control system of the apparatus of the present invention.

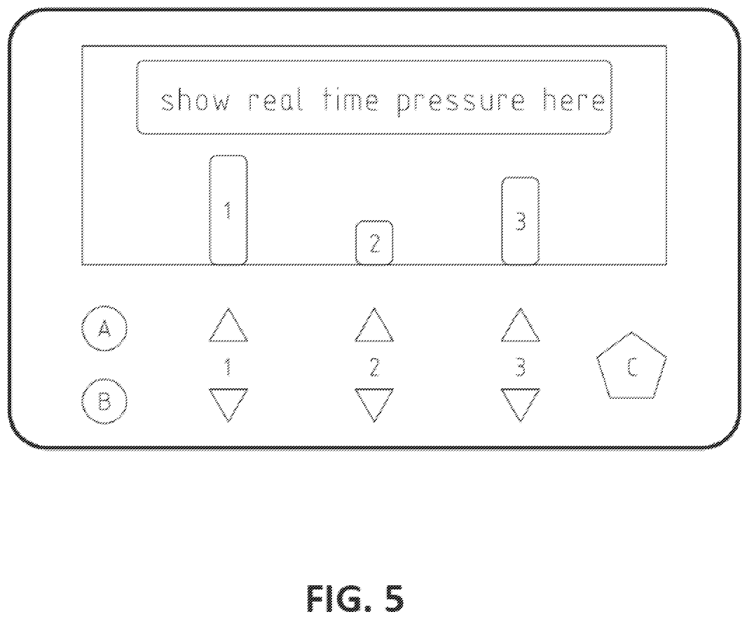

FIG. 5 is a front view of an appropriate controller for the apparatus of the present invention.

### DESCRIPTION

With reference to FIG. 1, the apparatus for spinal traction and lower back exercise of the present invention comprises a spinal traction assembly 100, a back exercise bench assembly 200 and a support structure 300.

The supporting structure 300 comprises a front floor bar 301 and a rear floor bar 302, a front crossbeam 310 and rear crossbeam 320. The front floor bar 301 and the rear floor bar 302 extend in a direction perpendicular to the front crossbeam 310 and rear crossbeam 320 respectively. The longer length of the front floor bar 301 and the rear floor bar 302 provide stability to the apparatus.

The front floor bar 301 and the rear floor bar 302 are bolted to front crossbeam 310 and rear crossbeam 320 respectively. Front crossbeam 310 and rear crossbeam 320 are bolted together. Reinforcement rods 330 form a triangle with front crossbeam 310 and rear crossbeam 320, for increased stability.

The seat 140 is mounted on the rear crossbeam 320. The seat is inclined with the inclination angle of the rear crossbeam 320, therefore the rear of the seat 140 is lower than the front of the seat 140.

At the rear end of the seat 140, is a backrest 110 which is attached to trolley 124 that moves in tracks 122 on the driving mechanism backing 121. The lower end of the driving mechanism backing 121 is connected by pins to rear cross beam 320.

With the support of the backrest strut 111, driving mechanism backing 121 and the rear crossbeam 320 form an angle which can be varied by repositioning backrest strut 111 on backing 121.

On both sides of the upper face of the backrest 110, are located, respectively a left arm support 151 and a right arm support 152. Both arm supports 151, 152 are perpendicular to the surface of the backrest 110. Both left arm support 151 and right arm support 152 are connected to the trolley 124 with a sliding connection that allows both left arm supports 151 and right arm supports 152 to slide in the left and right directions. Such sliding provides the possibility for users of different chest widths to use the apparatus.

At the top end of the front crossbeam 310, extending upwardly is vertically adjustable leg pad 160, mounted on a sleeve with a conventional height adjustment latch which provides different positions whereby the pad can be moved up or down to accommodate persons with different thigh length.

In the middle section of the front crossbeam 310, is a foot holder 180 which is secured to the front crossbeam 310. The foot holder is T-shaped. The bottom of the T is pin-connected to the front crossbeam 310 at the foot holding pin joint 190. The top of the T is perpendicular to the line connecting the front crossbeam 310 and rear crossbeam 320.

When a user uses the spinal traction assembly 100, he may need to first adjust the height of the backrest 110 to put the arm holders 151, 152 in a correct initial position by moving the backrest 110 to fit the height of his armpits, as explained below. He then sits on the seat cushion 140 facing the front crossbeam 310. The back is rested against the backrest 110. The distance between the left arm holder 151 and the right arm holder 152 is adjusted to suit the chest width of the user so that the left arm holder 151 and the right arm holder 152 are placed under the user's arm left axilla (armpit) and right axilla respectively. Then, the legs are lifted up and backs of the knees are placed over the leg pad 160. The dorsum of foot may be placed under the T top of the foot holder 180.

The user is then ready to use the spinal traction assembly 100.

The spinal traction assembly 100 comprises a drive mechanism 120 as shown in FIG. 2. The drive mechanism 120 is a combination of several components. The components of the drive mechanism are located on the driving mechanism backing 121. The lower end of the driving mechanism backing 121 is pin-connected to the rear crossbeam 320, and the upper end of the driving mechanism 121 is supported by the backrest strut 111. The backrest strut 111 is capable of adjusting the support position on the back of the driving mechanism backing 121, thereby adjusting the inclination angle of the driving mechanism backing 121.

On the upper side of the driving mechanism backing 121, in the longitudinal direction of driving mechanism backing 121, are guideway tracks 122 on each side of the mechanism.

The guideway tracks 122 accommodate the wheels 126 of trolley 124, on which arm holders are mounted, and lower support plate 136. As will be explained below, trolley 124 and lower support plate 136 are spaced apart by rod 130 that is connected at one end to an electric motor 123 (see FIG. 3) or extends from a pneumatic cylinder 132 (see FIG. 3a). Accordingly, trolley 124 and lower support plate 136 can be moved together up or down the track 122 so as to be set at an appropriate height for a user.

In order to maintain the assembly comprising the trolley 124 and lower support plate 136 at an appropriate height, a series of holes 201 preferably threaded holes, are formed in backing 121 near the lower end thereof, to accommodate a stop 202 robust enough to support the weight of the said assembly plus the weight of a user being lifted. As illustrated in FIG. 2, stop 202 may be a large diameter bolt with a knurled handle. Before using the device, therefore, a user will adjust the position of the stop to the appropriate hole so that their arms file comfortably over arm holders 151, 152.

In the space on the underside of trolley 124 between the two sets of trolley wheels is located a motor housing 129 containing a motor 123 (also referred to herein as an actuator) which in FIG. 3 is shown to be an electric motor mounted to a tubular housing 128 containing rod 130. Rod 130 is extendible and retractable in housing 128 by the action of motor, for instance by providing a rack and pinion gear or a screw gear between motor 123 and rod 130. Other arrangements will be obvious to one skilled in the art. A suitable motor for use with the present invention is a linear actuator, sold under the designation YM-TGA-300 by Derock Linear Actuator Technology Co., Ltd.

Motor 123 is actuated by a remote control which may be wired by cable 131 to motor 123. The lower end of rod 130 is connected to a mounting block 134 on lower support plate 136 that is provided with wheels moveable in track 122. A pressure sensor 125 is located at the lowermost end of rod 130, to measure the downward pressure exerted by rod 130, and cut power to motor 123 if this pressure exceeds a predetermined amount. A suitable sensor is made by B & B Thermo-Technik GmbH and sold as model number CZ1 240F.

FIG. 3a, shows that motor 123 may be replaced by a pneumatic piston 138, receiving gas pressure by a pneumatic line 133 connected to a source of gas pressure.

A piston rod 135 extends from cylinder 138 and is connected to mounting block 134. Generally speaking, a pressure sensor is not used on connection with a pneumatic cylinder, but rather a pressure gauge 133a is located in line 133.

On the upper side of trolley 124, on the opposite side to motor 123, are left arm holder 151 and right arm holder 152. Slide guide 127 guides left 151 and right arm holder 152 slidably mounted on the upper side of the trolley 124. The backrest 110 is mounted above slide guide 127. As can be seen in FIGS. 2 and 3a, there is a slide guide 127 associated with each of the left 151 and right 152 arm holder. The slide guides are stacked on top of each other, and slide on the upper surface of trolley 124. The guides 127 are attached to trolley 124 by a series of short bolts or rivets that project through aligned slots 137. Since there are a plurality of slots 137, the arm holders 151, 152 can hold heavy persons without bending.

When motor 123 is activated, the rod 130 of the motor 123 pushes toward the lower end of the driving mechanism backing 121, thus pushing the trolley 124 upwards. This drives backrest 110 with left arm holder 151 and right arm holder 152 upwards.

Since the leg pad 160 holds user's legs, as the left arm holding 151 and right arm holding 152 move upwards, therefore, the user achieves spinal traction by lifting the user's buttocks off the seat.

It will be understood, as noted above, that actuator 123 may be pneumatic or electric. If it uses a pneumatic cylinder 138, the piston is connected to the trolley 124, and the cylinder 138 is connected to mounting block 134 on lower support plate 136 (or vice-versa). Extension of the piston will then cause the trolley to move upwardly away from the mounting block and then release of pressure will permit the piston to retract in a response to the weight of the user.

Whether the actuator is pneumatic or gear-driven it is connected to a controller that is programmed to lift the trolley, hold it up for a predetermined length of time, and then lower it gently. This process is repeated, alternatively subjecting the user's back to traction and then rest, for a predetermined or user controlled number of cycles. This provides the benefit of permitting the user to relax the back muscles between lifts until, after several repetitions, the muscles will remain relaxed during the traction period, which increases the effectiveness of the traction.

A controller cycle for the apparatus of the electric motor versions of the present invention is shown schematically in FIG. 4, and a screen for a hand held controller is shown in FIG. 5. The hand held controller may include controls as follows:

Button A, power on button. That control on and off. When switch turns on, the screen is power on, but the actuator does not move, which gives user time to set the control and to get time to be ready.

Button B, is a start button, when all settings are done, user will press start button and the actuator start to move.

Button C, is a large red emergence stop button, which stops actuator move forward and lets it retreat to unloaded position and relax pressure.

Buttons 1, is a pair of pressure setting buttons, including an up arrow and a down arrow. This sets the maximum stretch pressure for each user. The 1 on the screen is a bar graphic showing the pressure reading. The screen graphic changes, going up and down as the setting button pressed.

Buttons 2, is a pair of pause time setting buttons with an up arrow and a down arrow. This pair of buttons controls the pause when actuator reaches its maximum loads, keep the pressure for certain seconds, and also sets the pause time at the zero load position. The bar on the screen shows the time in second in a digital way and graphic way.

Buttons 3, is a pair of number of circles buttons. Up arrow and down arrow. The controller has a circle button, which controls how long a session is, in cycles, or time, as desired.

The controller may be connected by a cable to the actuator, or it may be wirelessly connected by any conventional means such as Bluetooth™.

The apparatus of the present invention may also be used as a Roman Chain exercise device. The user stands on foot plate 210, facing the leg holder. The leg pad height is adjusted to be at the height of the user's hip point. The user then uses the Roman chain in a normal way, leaning forward at the hips, and the strengthening the body, to exercise the lower back muscles.

1. A device for physiotherapy comprising: at least a seating surface and a back rest;
said back rest being provided with arm holders positionable under a person's underarms; and
said back rest also being provided with powered means to move said arm holders in a direction away from said seating surface, thereby to lift a person off the seating surface, and to return the person to the seating surface.

2. The device as claimed in claim 1, wherein said back rest is at an angle of 90° or greater to said seating surface.

3. The device as claimed in claim 1, wherein said seating surface is mounted on a first beam extending at an angle from a floor contacting lower end to an upper end connected to a second beam extending from the floor to a point above the point of connection with said first beam.

4. The device as claimed in claim 1, wherein said back rest is mounted on a third beam that extends upwardly from the first beam.

5. The device as claimed in claim 1, wherein said powered means comprises;
a lower element that can be placed in a fixed position relative to said seating surface, an upper element that is connected to said arm holders and is moveable relative to said lower element; and
an actuator element extending between said lower element and said upper element.

6. The device as claimed in claim 5, wherein said actuator element is functionally connected to a power element to cause said upper element to move away from the lower element.

7. The device as claimed in claim 6, wherein the power element is an electric motor including drive means to power said actuator to move said upper element away from said lower element, and permit said upper element to return to its original position.

8. The device as claimed in claim 6, wherein said power element is a pneumatic cylinder connected to a source of compressed air, and said actuator is a piston rod extending from said pneumatic cylinder.

9. The device as claimed in claim 7, wherein said power element is connected to a controller that is operable to operate the actuator and lift the upper element in a cyclic manner of lift, wait, and lower, for preselected or programmable length of time.

10. The device as claimed in claim 8, wherein said pneumatic cylinder is connected to a controller to permit a person to pressurize the cylinder and thereby raise the upper element, and depressurize the cylinder to lower the upper element as desired.

11. The device as claimed in claim 5, wherein said back rest is connected to said upper element.

12. The device as claimed in claim 11, further comprising a back support mounted on said third beam and having tracks formed therein to accept wheels provided on at least said upper element.

13. The device as claimed in claim 11, wherein said lower element is also provided with wheels that fit in said tracks, and stop means are provided to limit the extent of downward travel in said tracks by said lower element.

14. The device as claimed in claim 13, wherein said stop means comprise a bolt co-operable with any one of a series of threaded holes at different heights in said back support.

15. A device for physiotherapy, comprising: a structural frame with a first frame member having a first floor engaging base a second frame member extending away from the first frame member near an upper end thereof remote from said floor engaging base and terminating in a second floor engaging base; and a third frame member extending upwardly from said second frame member;
said first frame member having, at its uppermost end one or two pads to accommodate the legs of a user;
said second frame member having a seating surface connected thereto, for a user to sit on;
said third frame member having a rigid element mounted thereon, with laterally spaced apart tracks in which is slidably mounted a back rest device;
said back rest device having a lower portion, and an upper portion, the lower portion and upper portion of the back rest device each being provided with a plurality of wheels that fit in said tracks to permit said lower and upper portions to move in said tracks, said lower and upper portions being joined together by an actuator means that comprises an elongated rod extending between the lower and upper portions;
said upper portion of said back rest comprising a pair of arm holders that can be moved apart a selected distance to accommodate different sized users; and
wherein said actuator means is functional to push said upper portion of said back rest away from said lower portion, and to return the upper portion to a rest position, thereby to lift the weight of a user who is seated on the seating surface, with their legs over the pad on the first frame member, and their arms over the arm holders, and to return the user to a rest position, repeatedly.

16. The device as claimed in claim 15, wherein a footrest is provided at the lowermost end of said first frame member.

17. The device as claimed in claim 16, wherein a leg support is provided in connection with said frame member, vertically spaced from the floor engaging end of the first frame member.

18. The device as claimed in claim 17, wherein
said leg support is T-shaped, and is hingedly connected at the base position of the T to the first frame member, whereby
the cross portion of the T can be pivoted away from the first frame member to permit a person to stand with their feet on the foot rests, their calves against the T-shaped leg support, and
their waist at the padded upper end of the first frame member, thereby to use the device to perform back extension exercises in the manner of a Roman chair.

19. The device as claimed in claim 18, wherein the cross portion of the T-shaped leg support is padded.

20. The device as claimed in claim 15, wherein
said actuator comprises an electric motor affixed to a selected one of the upper and lower portions of the back rest device and having a rod extending therefrom;
said motor selectively or programmably driving said rod in a first direction to extend said upper portion of the back rest away from the lower portion of the back rest, and
in a second direction to retract said upper portion of said back rest toward the lower portion of the back rest.

21. The device as claimed in claim 15, wherein
said actuator is a pneumatic cylinder connected to a source of compressed gas and having an extensible rod extending therefrom;
a selected one of the cylinder and the rod being connected to the upper position of the back rest device; and
the other of the rod and cylinder being connected to the lower portion of the back rest device;
whereby selective pressurization of the cylinder with pressurized gas extends the rod from the cylinder to urge the upper portion of the back rest device up to raise the user, and depressurization of the cylinder permits the upper portion of the back rest device to return.
